(19) United States
(12) Patent Application Publication
(10) Pub. No.: US 2008/0294551 A1
(43) Pub. Date: Nov. 27, 2008

(54) Cross-Border Remittance

(76) Inventors: Ernesto Degenhart, Guatemala (GT); Alex Cooper, Haworth, NJ (US); Neil Steinhardt, North Caldwell, NJ (US)

Correspondence Address: TORYS LLP, 79 WELLINGTON STREET WEST, SUITE 3000, BOX 270, TD CENTRE, TORONTO, ON, M5K 1N2, CA

(21) Appl. No.: 12/021,710

(22) Filed: Jan. 29, 2008

Related U.S. Application Data
(60) Provisional application No. 60/887,046, filed on Jan. 29, 2007.

(51) Int. Cl. G06Q 20/00

(52) U.S. Cl. 705/39

(57) ABSTRACT

Systems and methods for cross-border payment of accounts, and other remittance, resulting from provision of goods and services via a trusted agent. In particular, the invention provides systems, methods, and computer programming useful in making, accepting, and processing safe and reliable electronic payment of such debts. The invention is also useful in prepayment for goods and services such as pre-paid telephone or other communication cards and accounts. In some embodiments, such systems and methods proceed in real-time.

### PRIORITY CLAIM AND INCORPORATION BY REFERENCE

This application claims the benefit of and incorporates by this reference U.S. provisional patent application 60/887,046 entitled CROSS-BORDER REMITTANCE and filed 29 Jan. 2007 including any and all appendices and other documents attached thereto.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

This application contains material relating to the provision of financial services. The provision of some financial services is regulated, as for example by the United States Government, the various State governments, and other governmental agencies within the United States and elsewhere. The disclosure herein is made solely in terms of logical and financial possibility and advantage, without regard to possible statutory, regulatory, or other legal considerations. Nothing herein is intended as a statement or representation of any kind that any method or process proposed or discussed herein does or does not comply with any statute, law, regulation, or other legal requirement whatsoever, in any jurisdiction; nor should it be taken or construed as doing so.

### FIELD OF THE INVENTION

The present invention relates to payment remittance and more specifically to cross-border payment remittance that may be substantially in real-time.

### BACKGROUND OF THE INVENTION

Consumers are purchasing or spending large amounts of money and purchasing large numbers of products, services and the like. Often such purchases involve setting up accounts with one or more payees—the consumer then providing money to the one or more payees for payment towards the accounts for these products and services. Although often for themselves, consumers also want to make payments towards other people's accounts—such as those belonging to their parents, children, or other relatives.

At the same time, financial systems and financial institutions are becoming increasingly sophisticated and complex. This allows more transactions to be effected remotely or using technology such as computers and the Internet or other networks.

Although consumers' purchases may be growing and more transactions may be effected using technology such as computers, these developments are not occurring concurrently throughout the world and concurrently throughout populations in a given country.

Many people do not have bank accounts, and hence cannot do on-line banking for themselves or for their family. Further, many people provide money to family members or others, possibly in other countries, who may not make as much money. Historically it has been difficult to ensure that the payment was received by the family member or was directed to a particular account (perhaps such as an important account like electricity) and difficult to effect such payments particularly if they were between countries and performed by those not having on-line banking abilities. Therefore, there has existed a need for a method of remitting payment by a payor to a payee that may be effected between countries, be initiated using cash or without on-line payments, that may be applied to a particular account and confirmed as such.

### SUMMARY OF THE INVENTION

In various aspects the invention provides methods of remitting payment, comprising receiving from a payor in a first currency jurisdiction cash to be applied in payment against an account maintained in a second currency jurisdiction by a payee for at least one of goods delivered and services rendered by the payee, the cash received in currency of the first currency jurisdiction, associating with machine-readable data identifying the payee, machine-readable data identifying the account and an amount to be applied in payment against the account, providing the data identifying the payee, the data identifying the account, and the data identifying the amount to a payment clearing server, for payment of the amount to the payee through the payment clearing server by a trusted agent having electronic payment capability in the second currency jurisdiction, receiving, from the trusted agent through the payment clearing server, machine readable-data confirming that payment of the amount against the account has been accepted, and providing to the payor in human-readable form confirmation that the payment was made.

The amount to be applied in payment against the account and associated with the data identifying the payee may be identified in currency of the second currency jurisdiction. The amount to be applied in payment against the account and associated with the data identifying the payee may be identified in currency of the first currency jurisdiction. The method may comprise refunding to the payor any overpayment and the overpayment may comprise a failed payment. The method may occur in real-time and a payor may be provided confirmation that the payment was made in real-time.

In other aspects the invention provides methods of remitting payment, comprising receiving from a remittance collector in a first currency jurisdiction machine-readable data identifying a payee, an account maintained in a second currency jurisdiction for at least one of goods delivered and services rendered by the payee, and an amount collected from a payor for application as payment against the account, the amount collected in currency of the first currency jurisdiction, providing the data identifying the payee, the account, and the amount to be paid against the account to a trusted agent having electronic payment capability in the second currency jurisdiction, for payment by the trusted agent of the amount against the account, receiving, from the trusted agent, machine readable-data confirming that payment of the amount against the account has been accepted by the payee, and providing the data confirming payment of the amount to the remittance collector, for use by the remittance collector in providing to the payor, in human-readable form, confirmation that the payment has been made.

The amount to be applied in payment against the account and associated with the data identifying the payee may be identified in currency of the second currency jurisdiction. The amount to be applied in payment against the account and associated with the data identifying the payee may be identified in currency of the first currency jurisdiction. The method may be performed in real-time.

In other aspects the invention provides methods of collecting payments for remittance against a plurality of accounts, comprising receiving from at least one remittance collector in a first currency jurisdiction machine-readable data identifying a plurality of payees, a plurality of accounts maintained in at least one second currency jurisdiction for at least one of goods delivered and services rendered by the payees, and amounts collected from a plurality of payors for application as payment against the accounts, the amounts collected in currency of the first currency jurisdiction, providing the data identifying the payees, the corresponding accounts, and the amounts to be paid against the accounts to at least one trusted agent having electronic payment capability in the second currency jurisdiction, for payment by the at least one trusted agent of the amounts against the accounts, receiving, from the trusted agent, machine readable-data confirming that payment of the amount against the account has been accepted by the payee, and substantially simultaneously collecting the plurality of amounts from the at least one remittance collector.

The collecting the plurality of amounts may comprise electronically collecting the amounts. The collecting the plurality of amounts substantially simultaneously may occur periodically.

In other aspects the invention provides computer usable media having computer readable code embodied therein for causing a computer to receive from a payor in a first currency jurisdiction cash to be applied in payment against an account maintained in a second currency jurisdiction for at least one of goods delivered and services rendered by the payee, the cash received in currency of the first currency jurisdiction, associate with machine-readable data identifying the payee machine-readable data identifying the account and an amount to be applied in payment against the account, provide the data identifying the payee, the data identifying the account, and the data identifying the amount to a payment clearing server, for payment of the amount to the payee through the payment clearing server by a trusted agent having electronic payment capability in the second currency jurisdiction, receive, from the trusted agent through the payment clearing server, machine readable-data confirming that payment of the amount against the account has been accepted, and provide to the payor in human-readable form confirmation that the payment was made.

The amount to be applied in payment against the account and associated with the data identifying the payee may be identified in currency of the second currency jurisdiction. The amount to be applied in payment against the account and associated with the data identifying the payee may be identified in currency of the first currency jurisdiction. The computer usable medium may comprise computer readable code embodied therein for causing a computer to refund to the payor any overpayment and the overpayment may comprise a failed payment. The payor may be provided confirmation within 2 minutes of when the computer associates with machine-readable data identifying the payee machine-readable data identifying the account and an amount to be applied in payment against the account. The computer readable code may provide the payor confirmation in real-time.

In other aspects the invention provides computer usable media having computer readable code embodied therein for causing a computer to receive from a remittance collector in a first currency jurisdiction machine-readable data identifying a payee, an account maintained in a second currency jurisdiction for at least one of goods delivered and services rendered by the payee, and an amount collected from a payor for application as payment against the account, the amount collected in currency of the first currency jurisdiction, provide the data identifying the payee, the account, and the amount to be paid against the account to a trusted agent having electronic payment capability in the second currency jurisdiction, for payment by the trusted agent of the amount against the account, receive, from the trusted agent, machine readable-data confirming that payment of the amount against the account has been accepted by the payee, and provide the data confirming payment of the amount to the remittance collector, for use by the remittance collector in providing to the payor, in human-readable form, confirmation that the payment has been made.

The amount to be applied in payment against the account and associated with the data identifying the payee may be identified in currency of the second currency jurisdiction. The amount to be applied in payment against the account and associated with the data identifying the payee may be identified in currency of the first currency jurisdiction. The computer readable code may provide the payor confirmation in real-time.

In other aspects the invention provides computer usable media having computer readable code embodied therein for causing a computer to receive from at least one remittance collector in a first currency jurisdiction machine-readable data identifying a plurality of payees, a plurality of accounts maintained in at least one second currency jurisdiction for at least one of goods delivered and services rendered by the payees, and amounts collected from a plurality of payors for application as payment against the accounts, the amounts collected in currency of the first currency jurisdiction, provide the data identifying the payees, the corresponding accounts, and the amounts to be paid against the accounts to at least one trusted agent having electronic payment capability in the second currency jurisdiction, for payment by the at least one trusted agent of the amounts against the accounts, receive, from the trusted agent, machine readable-data confirming that payment of the amount against the account has been accepted by the payee, and substantially simultaneously collect the plurality of amounts from the at least one remittance collector. The collecting the plurality of amounts may comprise electronically collecting the amounts. The collecting the plurality of amounts substantially simultaneously occurs periodically.

In another aspect of the invention there is a system for processing remittance payments, the system comprising one or more computer processors and computer readable media configured for causing the one or more processors to, receive from a payor in a first currency jurisdiction cash to be applied in payment against an account maintained in a second currency jurisdiction for at least one of goods delivered and services rendered by a payee, the cash received in currency of the first currency jurisdiction, associate with machine-readable data identifying the payee machine-readable data identifying the account and an amount to be applied in payment against the account, provide the data identifying the payee, the data identifying the account, and the data identifying the amount to a payment clearing server, for payment of the amount to the payee through the payment clearing server by a trusted agent having electronic payment capability in the second currency jurisdiction, receive, from the trusted agent through the payment clearing server, machine readable-data confirming that payment of the amount against the account has been accepted, and provide to the payor in human-readable form confirmation that the payment was made.

The amount to be applied in payment against the account and associated with the data identifying the payee may be identified in currency of the second currency jurisdiction. The amount to be applied in payment against the account and associated with the data identifying the payee may be identified in currency of the first currency jurisdiction. The computer readable media may be configured for causing the one or more processors to refund to the payor any overpayment, which overpayment may comprise a failed payment. Processing remittance payments may occur in real-time.

In another aspect the invention provides systems for processing remittance payments, the system comprising one or more computer processors and computer readable media configured for causing the one or more processors to receive from a remittance collector in a first currency jurisdiction machine-readable data identifying a payee, an account maintained in a second currency jurisdiction for at least one of goods delivered and services rendered by the payee, and an amount collected from a payor for application as payment against the account, the amount collected in currency of the first currency jurisdiction, provide the data identifying the payee, the account, and the amount to be paid against the account to a trusted agent having electronic payment capability in the second currency jurisdiction, for payment by the trusted agent of the amount against the account, receive, from the trusted agent, machine readable-data confirming that payment of the amount against the account has been accepted by the payee, and provide the data confirming payment of the amount to the remittance collector, for use by the remittance collector in providing to the payor, in human-readable form, confirmation that the payment has been made.

The amount to be applied in payment against the account and associated with the data identifying the payee may be identified in currency of the second currency jurisdiction. The amount to be applied in payment against the account and associated with the data identifying the payee may be identified in currency of the first currency jurisdiction.

In other aspects the invention provides systems for collecting payments for remittance to a plurality of accounts, the system comprising one or more computer processors and computer readable media configured for causing the one or more processors to receive from at least one remittance collector in a first currency jurisdiction machine-readable data identifying a plurality of payees, a plurality of accounts maintained in at least one second currency jurisdiction for at least one of goods delivered and services rendered by the payees, and amounts collected from a plurality of payors for application as payment against the accounts, the amounts collected in currency of the first currency jurisdiction, provide the data identifying the payees, the corresponding accounts, and the amounts to be paid against the accounts to at least one trusted agent having electronic payment capability in the second currency jurisdiction, for payment by the at least one trusted agent of the amounts against the accounts, receive, from the trusted agent, machine readable-data confirming that payment of the amount against the account has been accepted by the payee, and substantially simultaneously collect the plurality of amounts from the at least one remittance collector.

The collecting the plurality of amounts may comprise electronically collecting the amounts. The collecting the plurality of amounts substantially simultaneously occurs periodically.

### BRIEF DESCRIPTION OF THE FIGURES

The invention is illustrated in the figures of the accompanying drawings, which are meant to be exemplary and not limiting, and in which like references are intended to refer to like or corresponding parts.

FIG. 1 is a schematic block diagram of an embodiment of a system useful for implementing remittance processes in accordance with the invention.

FIGS. 2 and 3 are schematic diagrams of embodiments of process flows for remittance in accordance with the invention.

### DETAILED DESCRIPTION OF THE PREFERRED EMBODIMENTS

Preferred embodiments of methods, systems, and apparatus according to the invention are described through reference to the Figures.

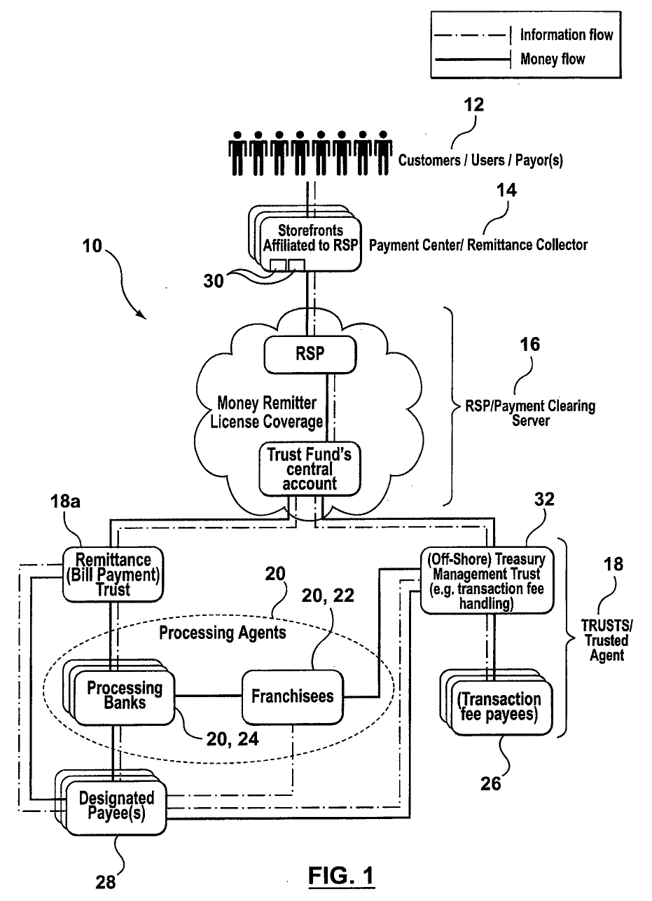

FIG. 1 is a schematic block diagram of an embodiment of a system 10 useful for implementing remittance processes in accordance with the invention.

As shown in FIG. 1, a number of parties may be involved in a system 10 for implementing processes for holding or moving of funds on behalf of consumers or payors to make final remittance to designated payees 28 in accordance with the invention. Such parties may for example include payor(s) 12, remittance collector(s) 14 having one or more POS devices 30, payment clearing server(s) 16, trusted agent(s) 18, processing agent(s) 20, and payee(s) 28.

Exemplary payees 28 may include for example, mobile phone network operators, utility providers, retail, industrial or commercial stores, e-commerce websites offering various products or services, and/or any other entity(ies) maintaining accounts for products or services rendered. Some exemplary applications of systems according to the invention include:
(a) Cross-border bill payment of designated payees (28) in cash: e.g., immigrants, travelers or others located in foreign countries can pay bills for services rendered in their originating countries for example, on behalf of family members who have remained behind;
(b) Cross-border bill payment of designated payees 28 via prepaid debit cards: e.g., immigrants can pay bills for services rendered in their originating countries on behalf of family members using prepaid debits card integrated with the technology of the invention;
(c) Cross-border purchase of “small-ticket” or other items from multiple designated payees 28 (e.g. vendors) in cash or prepaid debit cards: Immigrants can buy products or services that will be delivered to their family members as gifts or support;
(d) Integration of cash payments with Internet-based Business to Consumer (B2C) sales: Based on the network of points of service that are interconnected with the technology of the invention, un-banked and under-banked customers who do not posses credit or debit cards can buy products and services from designated payees 28 such as Internet merchants who are affiliated with the service. Payments can be received at remittance collector systems 14 and forwarded electronically to the payees 28 for delivery of the goods or services requested;
(e) Integration of cash payments with Internet-based Business to Business (B2B) sales: Based on the fact that a large proportion of participants in network of points of service interconnected with the technology of the invention can be retailers who need to purchase goods and services from suppliers, the invention can include a catalog system that will allow payees 28 operating as suppliers to offer their goods and services to the potential buyers or payors, receive orders, wait for payment to be done in the network and deliver once payment is received. Payments can be received at the points of service 14 and forwarded electronically to merchants 28 for delivery of goods or services requested;
(f) Small Business to Small Business direct sales, both on a local and international levels; and
(g) Web Portals of vertical (specialized) or horizontal (generalized) organizational structures, where small and medium enterprises can affiliate and then interact to do business. Once system 10 has confirmed receipt of payment, the seller or payee 28 can ship its products either locally or oversees, with reduced risk of non-payment.

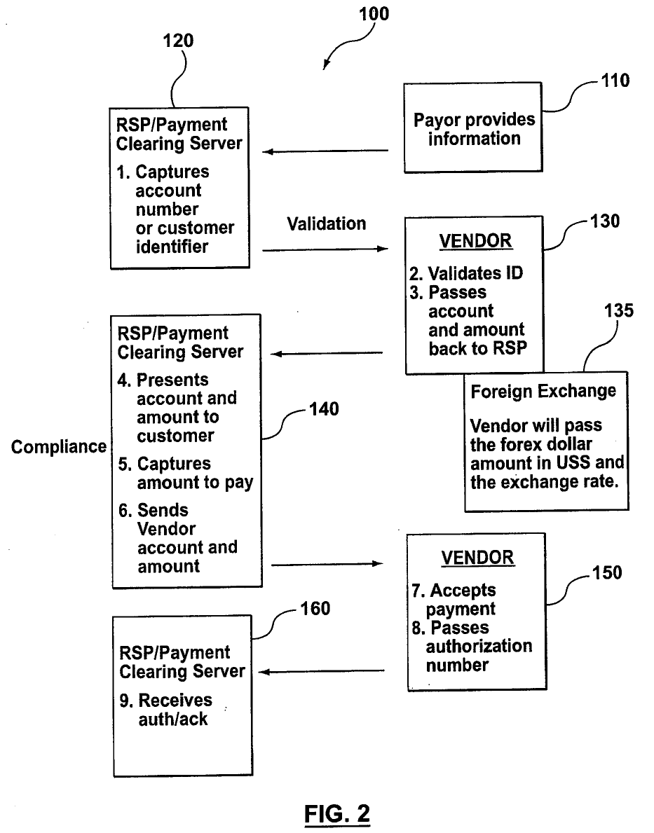

System 10 in FIG. 2 is well suited to implementation of the invention, and in particular for ensuring consumers or payors 12 and all other parties that there is a secure and verifiable chain of trust and custody for remitted funds. This may allow parties to provide payments to other parties before receiving the payment themselves—such as payment clearing server 16 paying trusted agent 18 before receiving any money from remittance collector 14 or trusted agent 18 paying payee 28 or processing agent 20 before receiving any money from payment clearing server.

Similarly, and with reference to FIG. 2, once payor 12 has received some form of receipt the payor 12 is assured by remittance collector 14 that paid funds were received by payee 28 and applied properly while remittance collector 14 may be similarly assured by payment clearing server 16. These assurances may be between parties in the same currency jurisdiction and may be contractual (oral, written, implied or a combination thereof). As used herein, “currency jurisdiction” may refer to a geographic location, such as a region, country or continent, where a given currency is used. A currency jurisdiction may be a country that uses a given currency or may be one or more countries that use a given currency (such as the European Union). It is to be understood that remittance may be effected between two currency jurisdictions or within one currency jurisdiction. Payment clearing server 16 may be assured by trusted agent 18, who may be located in or subject to jurisdiction by another currency jurisdiction. This assurance may be similarly contractual or involve an even more sophisticated trust agent. Further, trusted agent 18 may be assured by processing agent 20 or directly by payee 28 that paid funds were applied properly; again a contractual agent of some form and sophistication may exist.

In an alternative embodiment, one or more of remittance collector 14, payment clearing server 16, trusted agent 18, processing agents 20 and payee 28 may be the same party or entity, related parties, or part of a larger, for example corporate, structure or otherwise subject to common control. As such, one or more of the above assurances may be unnecessary or require less formality. One such example is shown in FIG. 1 as trusted agent 18a may be the same entity as payment clearing server 16 or processing agent 20 such as processing agent 20,24.

As will be understood by those skilled in the relevant arts, it may be beneficial that each party involved in a funds flow be in compliance with all applicable statutory and regulatory requirements, as for example by being either licensed money transmitter or agents of such, within each jurisdiction in which they are located or do business.

For example, in a currently-envisioned embodiment each payment center or remittance collector 14 is an agent of IPP of America, Inc. (“IPP”), which is a licensed Money Transmitter in each state from which cross-border bill payments are initiated in the United States. Such payment centers may be responsible for collection of funds from consumers. In some currently-contemplated embodiments only cash, and not other forms of payment or payment amounts, will be accepted from consumers, for example if payor 12 does not have a bank account in the currency jurisdiction of remittance collector 14 or simply prefers to use cash.

It may be required or otherwise desirable that payment center deposit funds collected each day into a designated one or more bank accounts following closing of a business session (e.g., a business day), and prior to opening of the next business session (e.g., by the following morning). The payment center controller or payment clearing server 16 has authorization to sweep the funds collected by its authorized payment centers for cross-border payments, including all applicable transaction fees payable to payment clearing server 16, payment center controller or any other party such as trusted agent 18, from the designated bank account of each payment center. For example, payment clearing server 16 such as IPP may intend to sweep the funds for all payments taken until 6:00 pm EST on the corresponding banking day. IPP may intend to send the funds for all payments taken until 6:00 pm EST less any applicable fees due to IPP, directly to a designated U.S. bank account used to pay designated payees 28 through the corresponding Trust(s) or trusted agents 18 on the following banking day.

In the contemplated embodiment shown in FIG. 2, trust or trusted agent 18 can comprise one or more bank accounts owned and/or administered by one or more banks or other entities in one or more target countries or other jurisdictions, on behalf of billers, payees 28, RSPs or payment clearing servers 16, and others to whom remittance is due as beneficiary(ies). A purpose of the trust or trusted agent 18 is to receive the funds deposited by payment clearing server 16 or RSP on behalf of its customers or payors 12 making cross-border remittances to designated payees 28. The Trust or trusted agent 18 is to administer in favor of the RSP or payment clearing server 16 (e.g., IPP) the transfer, registry and control of funds collected in the United States of America or other first currency jurisdiction in which remittance is to originate, due to remittances, collections and payments on behalf of third parties (payors 12), to the beneficial persons and Providers, such as payees 28, in other countries or jurisdictions in which the items were purchased or services were rendered, optionally using processing agents 20 as means to perform the transfer of funds.

In such currently-contemplated embodiments processing agents 20 are to be any suitably-qualified and authorized company(ies) that may be affiliated with the Trust or trusted agent 18, that are for example legally incorporated in each currency jurisdiction where there will be coverage of the services of remittances and collection of collections on behalf of third parties, subject of the present Trust. Exemplary processing agents 20 may include processing banks 20, 24 and franchisees 20, 22 that may be franchisees of any of the parties in system 10, including remittance collector 14, payment clearing server 16, and trusted agents 18. Duties of processing agents 20 are to include the transfer of collected funds, in accordance with agreements entered into with the Trust, to the Providers of Goods and Services (i.e., designated payees 20). The Trust will administer the third party collection in the territory of each currency jurisdiction or other jurisdiction covered by its services, in the name of the Designated Payees, using processing agents 20 as a means to transfer funds and using an electronic data switch for registry of such operations.

It is contemplated that the trust or trusted agent 18 will bear all fiduciary responsibility, such as to payment clearing server 16 or RSP, to ensure that funds are remitted to designated payee 28 for each payment transaction according to currency value stated when the transaction is accepted.

In various embodiments separate trust accounts can be maintained for transaction fees collected and owed to various parties, such as transaction fee payees 26 participating in remittance transactions. Such separate trust accounts may be maintained, for example, at transaction fee trust 32, which may be the same entity or a different entity from trusted agent 18 for a particular remittance transaction. In such embodiments it may be advantageous to provide that Trusts or trusted agents 18 used in actual remittance contain only funds to be used in such remittances on behalf of customers.

As will be readily appreciated by those skilled in the relevant arts, the invention further comprises suitably-programmed computer systems and communications devices, adapted to implement the various processes contemplated and operate all or any desired portion(s) of system 10; and suitably-configured software programming. For example, any one or more of remittance collector 14, payment clearing server 16, trusted agent 18, processing agents 20 and payee 28 may comprise one or more computer systems and communications devices. Such computer systems and communications devices may include personal computers, server computers, input/output device(s), auxiliary devices such as scanners or devices to access or store data and other components that may perform other functions of a typical computer system, or a system 10 according to the present invention, such as networking hardware. Without limiting the generality of the foregoing, such computer systems may be sophisticated servers, distributed computing architectures, or other complex computer systems but may also simply be a personal computer that is able to perform the desired functionality.

FIG. 2 is a schematic diagram of an embodiment of a process flow for remittance in accordance with the invention.

In the embodiment shown in FIG. 2, a remittance service provider (“RSP”) or payment clearing server offers cross-border bill payments and other remittance services (“Services”) at a plurality of eligible, authorized retail locations, or other transaction origination centers (“payment centers”) or remittance collectors. As will be apparent to those of ordinary skill in the relevant arts, once they have been made familiar with this disclosure, it may be advantageous to require that prospective payment center operators or remittance collectors be in current compliance with all applicable statutory or other regulatory requirements, e.g., in a state or other jurisdiction where all applicable money-transmission licenses have been obtained and are currently, and are current in collections and other obligations with the RSP(s) and others.

Each payment center or remittance collector 14 can be provided one or more payment devices (“POS device”), which can include any suitable system(s) or device(s), including for example one or more Personal Computers, point-of sale terminals such as suitably-configured cash registers or credit- or debit-processing devices, and/or self-service kiosks capable of sending payment transactions to a processing center operated by the RSP (“RSP Host”), or payment clearing server 10, via a communications network such as the internet or via dedicated telephone dial-up connections in real-time.

As shown at 110 in FIG. 2, consumers, payors such as payor(s) 12, or other users wishing to make a payment or other remittance can provide a retail clerk or other individual (including him or herself) operating the POS device, such as POS device 30, with specific information on the cross border bill payment to be made, including for example the name of the biller or other recipient of the remittance such as payee 28, an account number and the amount to be paid. The operator at the payment center or remittance collector can for example choose the payee from a list of available cross border payees (“Designated Payees” or “Payees”) or Vendors and enter the account and amount data into POS device 30.

At 120, the POS device can transmit the data to the RSP Host or payment clearing server, such as payment clearing server 16, for capturing, optionally in machine-readable form or via, for example a fax that is read by the RSP host or by communicating directly with an operator at the RSP Host, and may later (though it may be substantially in real-time) receive a confirmation from the RSP that the transaction is approved or rejected—such as at 160.

Process 100 may continue at 130 where a Vendor or Payee may validate or approve the transaction. The transaction can be approved if for example the transaction data comprises a valid Designated Payee ID, a valid account identifier, and an amount that is within Designated Payee tolerances and legal compliance. An RSP or Payee can for example refuse to accept a payment that is greater than $500 per transaction or more than $2,000 in aggregate for a 24 hour period based on its AML and FINCEN requirements. Also, based on the specific Designated Payee, a partial payment may or may not be allowed. If approved, the Payee at 130 may pass or send information, such as the account and amount, back to the payment clearing server.

The vendor, at 135, may further handle foreign exchange conversion, such as converting between currencies used in the currency jurisdiction of the payor and Payee. It is to be understood that such conversion or foreign exchange could be performed by other parties or entities and could occur at various stages during a transaction, and such alternatives are considered within the scope of the present invention.

If a transaction is accepted, then at 140 the payment clearing server may present information, such as the account and amount, to the payor. This may be presented to the payor, for example by a display on a POS device.

The POS device can display an amount that will be remitted in local currency. For example, if a consumer is paying $100 US for a Telemex Phone Bill and the current rate of conversion is 100 Mexican pesos to 1 US dollar, the customer account can be credited for 10,000 Mexican pesos.

The customer or payor can be required to pay a transaction or other fee to one or more of the payment clearing server or RSP, Trust or trusted agent or a processing agent, for each payment (for example, between $3-$5) that will be added to the amount remitted to the Designated Payee. Such fees may be grouped together or separately detailed for the payor. Additionally, such fees may be offered at a discount for example because of continued or repeated use, size of one or more transactions, or if one particular party or group of parties controls one or more of, for example, remittance collector, payment clearing server, trusted agent or processing agent.

Still at 140, the payment center operator can collect the total due from the customer and give the customer a printed receipt generated from the POS device, provide another receipt renderable in human-readable form, such as via an email or SMS, and/or provide a machine-readable receipt that may later be made ready by, for example, the same or another POS device. Alternatively, the receipt may be provided at 160, after an authorization number has been received by the payment clearing server. It is to be understood that as process 100 may occur substantially in real-time; the difference in providing the receipt may not be noted by a payor.

The receipt can include information sent as the designated payee name, account identification or verification, amount remitted in local currency, including the RSP transaction fee, a foreign exchange rate for the currency of remittance, and the amount credited to the account in local currency. The receipt can also confirm the name of the payment center, time and date of payment, phone number for RSP customer service, a unique reference number to identify and track the payment, and other desired or required information.

In order for a payment transaction to be approved and subsequently posted, as at 150, data associated with each transaction can be transferred, optionally in machine-readable form, from an RSP Host to a Trust Host or trusted agent such as trusted agent 18, in real-time via an optionally secure connection. Upon successful posting, the vendor may provide an authorization number back to the payment clearing server at 150.

One or more Trust operators can maintain Trust Host computer systems in countries or other jurisdictions associated with the Designated Payees that will accept transactions from the RSP, and transmit transactions in real-time to the corresponding Designated Payees. The Trust can be responsible for providing electronic links either by connecting directly to the Designated Payees' own payment systems or through approved processing agents such as processing agents 20, or third- or fourth-party institutions that will process payments for each Designated Payee. It is to be understood that the manner by which the payment arrives at the Payee from a trusted agent can be accomplished in many ways, all of which are considered within the scope of the present invention. The Trust Host or trusted agent can be required to approve each RSP payment transaction within a designated period of time, so as to provide real-time remittance capabilities. The trusted agent or Trust Host can have the ability to validate account identifiers for each Designated Payee and, where possible, the Trust Host can also access the amount to be paid for the specific account and pass this data back to the corresponding RSP host, such as may be required at 130. The Trust Host can also provide the RSP host with a daily or other periodic or floating table of exchange rates to use for each local currency required. Once the Trust Host approves a transaction and the corresponding RSP acknowledges that the transaction has been finalized, the Trust Host can transmit data, optionally in machine-readable form, useful for completing the remittance transaction in real-time to the Designated Payee for posting to the account, for example as at 150.

As described herein, at 160 the payment clearing server may receive an authorization or acknowledgement that the payment has been posted and the transaction approved; and a receipt may be provided to a payor.

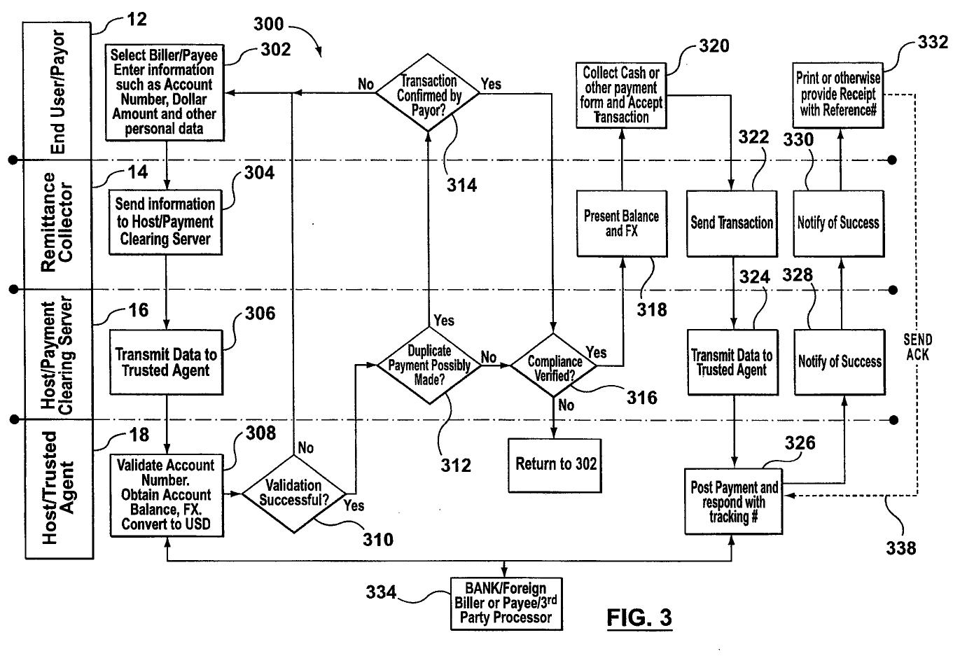

FIG. 3 is a schematic diagram of an embodiment of a process flow for remittance in accordance with the invention.

In the embodiment shown in FIG. 3, process 300 may be performed by, for example, a payor such as payor 12, a remittance collector such as remittance collector 14 (that may have an auxiliary device such as a printer and/or POS device 30), a payment clearing server such as payment clearing server 16 and a trusted agent such as trusted agent 18 acting collectively or as independent entities. It is to be understood that process 300 is one embodiment only; the order of the process may change and the party that may perform aspects of the process may change. Any of such changes are considered to be within the scope of the present invention.

Process 300 may be performed in more than one currency jurisdiction and in a short period of time, such as in real-time. “Real-time” may have different precise meanings or time restrictions depending on the embodiment of a process flow for remittance but generally means at the best speed of automatic data processing, without administrative delays and in any case within such a period that a payor 12 might reasonably be expected to wait at a POS device 30 without interrupting business flow at payment center 14. In some embodiments, or portions thereof, requiring more interaction or information from payor 12 or an operator of POS device 30, or printing of receipts, may take more time, but may still be considered “real-time”. Other embodiments, or portions thereof, for example requiring substantially no human interaction may proceed more quickly and in “real-time”. For example, the time required may be one or two minutes or less and preferably 30 seconds or less, for example from when cash is collected by remittance collector 14, to allow a payor, such as payor 12, to receive a receipt (such period of time may essentially correspond to when the computer associates with machine-readable data identifying the payee, machine-readable data identifying the account and an amount to be applied in payment against the account). In such an example, processing may occur very quickly (ie. within a few seconds) and the printing may take the majority of the time to complete the transaction. As a further example, the entirety of process 300 may occur within 5 minutes and preferably in less than 3 minutes. Such real-time performance may allow the payor to leave the remittance collector being assured that the payment has been made.

Process 300 can begin at 302 where a biller or payee is designated and information is entered to allow remittance of a payment to a payee. Such information may include an account number, a dollar amount and possibly other information to allow correct remittance of a payment to a payee for application to a particular account. It is to be understood that one or more payors may remit payment to one or more payees—either in one transaction or multiple transactions distributed over a period of time. The information may be entered into a device, such as a POS device, that may accept such information so that it may be data in electronic form that can be sent in or using signals; such device may be part of remittance collector 16. As shown in FIG. 3, payor 12 may perform 302.

Process 300 can continue at 304 where information provided by payor 12 at 302 may be sent as data in signals by a remittance collector, such as remittance collector 14, to a payment clearing server 16.

After the information or data is sent to a payment clearing server 16 at 304, at 306 a payment clearing server, such as payment clearing server 16, may transmit the information or data to a trusted agent, such as trusted agent 18. As in 302 and 304, the transmission at 306 may be electronic, such as via signals, and may be in human-readable or machine-readable form. There may be advantages to transmission in any of these ways but machine-readable form may easily facilitate provision of receipts and maintenance of records as data in signals may be stored at a storage device of various parties and may be directly provided to an auxiliary device, such as a printer, for printing a receipt.

Process 300, steps 302, 304 and 306 may be essentially performed or otherwise effective in a first currency jurisdiction, such as in the United States, as it is contemplated that in some embodiments the payor, remittance collector and payment clearing server may be in the same currency jurisdiction. Step 308 may be performed in a second currency jurisdiction as the trusted agent may be in a second currency jurisdiction, such as in Guatemala. For the purposes of the embodiment of the invention as shown in FIG. 3, such parties may be assumed to be located in or otherwise subject to legal or administrative control these first and second countries.

At 308, information collected at 302 can be validated by a trusted agent, such as trusted agent 18. Such validation may for example, include checking an account number or other account identifying information, unique identification data such as names and passwords, or other required information. As the information may be received as data in signals, validation may involve obtaining the data from the signals and comparing various information that may be contained in the data to other data or information already in a storage device. Validation at 308 may further include obtaining an account balance of the account specified by a payor at 302, for example to determine that there is an outstanding balance to pay. Additionally, a foreign exchange conversion may occur to provide an account balance in, for example, US dollars or the currency of the first currency jurisdiction at which 302, 304 and 306 may have occurred. It is to be understood that such conversion may occur at various portions of process 300 and be performed by various entities including any of remittance collector 14, payment clearing server 16 and trusted agent 18 and that such conversion at 308 is exemplary only.

At 310, process 300 queries whether the validation was successful. Successful validation may indicate that a payor has provided a valid account number, password, amount to be paid, account holder name, or other acceptable data. Unsuccessful validation may occur for many reasons; exemplary causes may include providing an account number that does not exist, specifying an unacceptable dollar amount to be remitted, such as being too large or too small or only a portion of the full amount owed, or any other reason that a financial transaction may fail. If validation fails at 310, then process 300 returns to 302.

If validation is successful at 310, then process 300 continues at 312 to query whether a duplicate payment might have been made. Such a determination may be based on, for example, identification that a previously posted remittance is similar to the remittance currently being contemplated, such as a remittance for the same amount of money, which occurred during a designated period, and/or were made by the same payor or remittance collector. It is to be understood that many forms of detection of duplicate payments may be utilized and such may depend on, for example, the payee, the payor, the nature of the service or product, or various other factors. It is also to be understood that such query may be omitted or may be encompassed in validation at 310.

If at 312 a possible duplicate payment is detected, then process 300 continues at 314 where a confirmation of the duplicate transaction may occur. This confirmation may involve, for example, a payor confirming there is a duplicate, indicating that they wish to remit the duplicate payment, or a remittance collector or other party acknowledging that a duplicate payment is to be made. Although 314 is shown in FIG. 3 to be performed by payor such as payor 12, it may be performed by other entities such as remittance collector 14. Similarly, although payment clearing server 16 is shown in FIG. 3 to be performing 312, it is to be understood that other entities, such as remittance collector 14 or trusted agent 18 may also perform duplicate payment detection. If there is no confirmation that a duplicate payment is to be made then process 300 returns to 302.

If there is no duplicate payment at 312 or if the duplicate payment is confirmed at 314, process 300 continues at 316 where compliance is verified. Compliance may be verified by payment clearing server 16, and may involve, for example, assessing that there is no duplication of payment, that payment clearing server is able to, and will, effect the payment to the particular payee, that regulatory or other legal compliance has been met, or other compliance that may be required by payment clearing server 16 or other parties.

If compliance is verified at 316, process 300 may proceed to 318 where information about the remittance or account, such as financial information that may include a new balance, foreign exchange, and/or recent payments, may be presented at remittance collector 14 and viewed by payor such as payor 12. Information that is presented at 318 may depend on such factors as privacy requirements, and access to information and operation of the various parties' systems that form part of system 10. Process 300 may then proceed to 320 where a payor may accept the transaction that has been validated and provide cash or other payment forms such as a credit or debit card. At 320, if a payor does not have a bank account, or otherwise wants to use cash, they may present such cash and remittance collector 14 can indicate that they have received the required payment to allow the remittance to proceed.

Process 300 may then proceed at 322 where remittance collector 14 may send the information to accept the transaction to payment clearing server 16. Sending the transaction at 322 may indicate, for example, that the appropriate cash or other payment has been received and that payor 12 wishes to proceed with the transaction.

Process 300 may continue at 324 where payment clearing server 16, having received information relating to the transaction from remittance collector 14 at 322, may transmit the information to a trusted agent, such as trusted agent 18 that may be in a second currency jurisdiction. As the information may be in electronic data, transmission may involve sending signals containing the data between entities and may involve further steps such as storing or extracting the information from the data contained in the signals.

At 326, trusted agent 18 posts payment to the particular account of a payee, as indicated at 334. This may involve posting the payment directly to the payee or posting to a processing agent such as processing banks 20, 24, franchisees 20, 22. Posting may be accomplished by extracting the payment amount from a signal received and applying that amount to the account, which may be accomplished by changing data stored at payee 28 that contains an account balance. In any case, posting of the payment is effected by trusted agent 18 and arrives at the payee who may respond to trusted agent 18 with a tracking number that may be unique to the transaction. The payee providing a tracking number may indicate, for example, that the payment has been successfully made and the payee considers the transaction complete. The tracking number may be stored by payee 28 as data and transmitted in a signal to trusted agent 18.

Trusted agent 18, having received a tracking number, provides this tracking number, or its own number that may relate to the tracking number, to payment clearing server 16. At 328 payment is posted at payment clearing server 16, which may be similar to posting payment at 326 or may involve one or more differences as required by, for example, payment clearing server 16 and its operation. Payment clearing server 16 may respond to remittance collector 14 with a reference number or tracking number. Such reference or tracking number may be the same as, or different from, the tracking number provided to trusted agent 18 or payment clearing server 16. Trusted agent 18 may store the received tracking number and/or its own tracking number, in storage. Such numbers may be stored as data and associated together, such as in a database.

The one or more tracking or reference numbers may each provide assurance between two or more parties that payment has been successfully made. For example, the tracking number provided to payment clearing server 16 at 326 assures payment clearing server 16 that trusted agent 18 has remitted the payment to the payee. In case of any problems that may arise, payment clearing server 16 would provide and rely on this tracking number. As described herein, one embodiment, the parties may further have a specific agreement (such as a trust agreement) that, possibly along with the tracking number, provides recourse between the parties. In another embodiment, the trust agent and payment clearing server may essentially be the same party (such as divisions of a larger corporate entity) and may not require a trust agreement but may use a tracking number simply to facilitate internal communication about the remittance.

Similarly the IPP or other reference number provided to remittance collector 14 by payment clearing server 16 at 328 assures the remittance collector, such as remittance collector 14, that this payment has been made. In case of any problems that may arise, remittance collector 14 would provide and rely on this reference number. This reference number, possibly in combination along with another contract (written, oral, or implied) between the parties, would provide recourse between the parties.

Continuing at 330, remittance collector 14 receives at least a reference number or other confirmation from payment clearing server 16 to notify that the transaction has successfully completed. Remittance collector 14 may receive this confirmation via a signal that sends data. Such notification may then be provided to the payor at 332. Notification may involve, for example, a human-readable or machine-readable indication of success, and it may be printed, electronic, or otherwise presentable to payor 12. Exemplary notifications may include a printed receipt, stub or bar code that may be read by a human or machine or an email or SMS communication.

Additionally, an acknowledgement (“ACK”) may be provided to trusted agent 18 when payor 12 has received their notification of success at 332, as indicated at 338. Such acknowledgment may involve a signal, that may be in machine-readable form, being sent by remittance collector 14 to payment clearing server 16 and then to trusted agent 18. As with many other portions of process 300, it is to be understood that this acknowledgment may occur in a number of different ways.

It is to be understood that many variations of the present method are contemplated. In one alternate embodiment, process 300 may be modified so that payor 12 provides cash, or other payment, to remittance collector 14 prior to any validation. Remittance collector 14 may then attempt to remit such payment to a payee and account as specified by payor 12. Validation, as at 310, may then occur, as may compliance verification at 316 (omitting to confirm or query whether there may be a duplicate payment). Process 300 may then continue as above at 322. As such, remittance may be achieved more quickly, but be more likely to have validation failures as a payor may have less information (such as the state of the account, the minimum payment etc) prior to attempting to make a remittance.

In a further, related embodiment, payor 12 may provide cash or other payment at 302 and remittance collector 14 may proceed to validated and post payment without further input from the payor. The payor, such as payor 12, may or may not be notified if a duplicate payment is detected. Again, remittance may be achieved more quickly, although a payor may have less information (such as about the state of the account, the minimum payment etc) prior to attempting to make a remittance, however the remittance collector may be provided any of such information, as in process 300, and may bring such to the attention of payor 12.

While the foregoing invention has been described in some detail for purposes of clarity and understanding, it will be appreciated by those skilled in the relevant arts, once they have been made familiar with this disclosure, that various changes in form and detail can be made without departing from the true scope of the invention in the appended claims. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

What is claimed is:

1. A method of remitting payment, comprising:
receiving from a payor in a first currency jurisdiction cash to be applied in payment against an account maintained in a second currency jurisdiction by a payee for at least one of goods delivered and services rendered by the payee, the cash received in currency of the first currency jurisdiction;
associating with machine-readable data identifying the payee, machine-readable data identifying the account and an amount to be applied in payment against the account;
providing the data identifying the payee, the data identifying the account, and the data identifying the amount to a payment clearing server, for payment of the amount to the payee through the payment clearing server by a trusted agent having electronic payment capability in the second currency jurisdiction;
receiving, from the trusted agent through the payment clearing server, machine readable-data confirming that payment of the amount against the account has been accepted; and
providing to the payor in human-readable form confirmation that the payment was made.

2. The method of claim 1, wherein the amount to be applied in payment against the account and associated with the data identifying the payee is identified in currency of the second currency jurisdiction.

3. The method of claim 1, wherein the amount to be applied in payment against the account and associated with the data identifying the payee is identified in currency of the first currency jurisdiction.

4. The method of claim 1, comprising refunding to the payor any overpayment.

5. The method of claim 4, wherein the overpayment comprises a failed payment.

6. The method of claim 1 wherein the payor is provided confirmation that the payment was made in real-time.

7. A method of remitting payment, comprising:
receiving from a remittance collector in a first currency jurisdiction machine-readable data identifying a payee, an account maintained in a second currency jurisdiction for at least one of goods delivered and services rendered by the payee, and an amount collected from a payor for application as payment against the account, the amount collected in currency of the first currency jurisdiction;
providing the data identifying the payee, the account, and the amount to be paid against the account to a trusted agent having electronic payment capability in the second currency jurisdiction, for payment by the trusted agent of the amount against the account;
receiving, from the trusted agent, machine readable-data confirming that payment of the amount against the account has been accepted by the payee; and
providing the data confirming payment of the amount to the remittance collector, for use by the remittance collector in providing to the payor, in human-readable form, confirmation that the payment has been made.

8. The method of claim 7, wherein the amount to be applied in payment against the account and associated with the data identifying the payee is identified in currency of the second currency jurisdiction.

9. The method of claim 7, wherein the amount to be applied in payment against the account and associated with the data identifying the payee is identified in currency of the first currency jurisdiction.

10. The method of claim 7 wherein the method is performed in real-time.

11. A method of collecting payments for remittance against a plurality of accounts, comprising:
receiving from at least one remittance collector in a first currency jurisdiction machine-readable data identifying a plurality of payees, a plurality of accounts maintained in at least one second currency jurisdiction for at least one of goods delivered and services rendered by the payees, and amounts collected from a plurality of payors for application as payment against the accounts, the amounts collected in currency of the first currency jurisdiction;
providing the data identifying the payees, the corresponding accounts, and the amounts to be paid against the accounts to at least one trusted agent having electronic payment capability in the second currency jurisdiction, for payment by the at least one trusted agent of the amounts against the accounts;
receiving, from the trusted agent, machine readable-data confirming that payment of the amount against the account has been accepted by the payee; and
substantially simultaneously collecting the plurality of amounts from the at least one remittance collector.

12. The method of claim 11, wherein collecting the plurality of amounts comprises electronically collecting the amounts.

13. The method of claim 11, wherein the collecting the plurality of amounts substantially simultaneously occurs periodically.

14. A computer usable medium having computer readable code embodied therein for causing a computer to:
receive from a payor in a first currency jurisdiction cash to be applied in payment against an account maintained in a second currency jurisdiction for at least one of goods delivered and services rendered by the payee, the cash received in currency of the first currency jurisdiction;
associate with machine-readable data identifying the payee machine-readable data identifying the account and an amount to be applied in payment against the account;
provide the data identifying the payee, the data identifying the account, and the data identifying the amount to a payment clearing server, for payment of the amount to the payee through the payment clearing server by a trusted agent having electronic payment capability in the second currency jurisdiction;
receive, from the trusted agent through the payment clearing server, machine readable-data confirming that payment of the amount against the account has been accepted; and
provide to the payor in human-readable form confirmation that the payment was made.

15. The computer usable medium of claim 14, wherein the amount to be applied in payment against the account and associated with the data identifying the payee is identified in currency of the second currency jurisdiction.

16. The computer usable medium of claim 14, wherein the amount to be applied in payment against the account and associated with the data identifying the payee is identified in currency of the first currency jurisdiction.

17. The computer usable medium of claim 14, comprising computer readable code embodied therein for causing a computer to refund to the payor any overpayment.

18. The computer usable medium of claim 17, wherein the overpayment comprises a failed payment.

19. The computer usable medium of claim 14 wherein the payor is provided confirmation within 2 minutes of when the computer associates with machine-readable data identifying the payee machine-readable data identifying the account and an amount to be applied in payment against the account.

20. The computer usable medium of claim 14 wherein the computer readable code provides the payor confirmation in real-time.

21. A computer usable medium having computer readable code embodied therein for causing a computer to:
receive from a remittance collector in a first currency jurisdiction machine-readable data identifying a payee, an account maintained in a second currency jurisdiction for at least one of goods delivered and services rendered by the payee, and an amount collected from a payor for application as payment against the account, the amount collected in currency of the first currency jurisdiction;
provide the data identifying the payee, the account, and the amount to be paid against the account to a trusted agent having electronic payment capability in the second currency jurisdiction, for payment by the trusted agent of the amount against the account;
receive, from the trusted agent, machine readable-data confirming that payment of the amount against the account has been accepted by the payee; and
provide the data confirming payment of the amount to the remittance collector, for use by the remittance collector in providing to the payor, in human-readable form, confirmation that the payment has been made.

22. The computer usable medium of claim 21, wherein the amount to be applied in payment against the account and associated with the data identifying the payee is identified in currency of the second currency jurisdiction.

23. The computer usable medium of claim 21, wherein the amount to be applied in payment against the account and associated with the data identifying the payee is identified in currency of the first currency jurisdiction.

24. The computer usable medium of claim 21 wherein the computer readable code provides the payor confirmation in real-time.

25. A computer usable medium having computer readable code embodied therein for causing a computer to:
receive from at least one remittance collector in a first currency jurisdiction machine-readable data identifying a plurality of payees, a plurality of accounts maintained in at least one second currency jurisdiction for at least one of goods delivered and services rendered by the payees, and amounts collected from a plurality of payors for application as payment against the accounts, the amounts collected in currency of the first currency jurisdiction;
provide the data identifying the payees, the corresponding accounts, and the amounts to be paid against the accounts to at least one trusted agent having electronic payment capability in the second currency jurisdiction, for payment by the at least one trusted agent of the amounts against the accounts;
receive, from the trusted agent, machine readable-data confirming that payment of the amount against the account has been accepted by the payee; and
substantially simultaneously collect the plurality of amounts from the at least one remittance collector.

26. The computer usable medium of claim 25, wherein collecting the plurality of amounts comprises electronically collecting the amounts.

27. The computer usable medium of claim 25, wherein the collecting the plurality of amounts substantially simultaneously occurs periodically.

28. A system for processing remittance payments, the system comprising one or more computer processors and computer readable media configured for causing the one or more processors to:
receive from a payor in a first currency jurisdiction cash to be applied in payment against an account maintained in a second currency jurisdiction for at least one of goods delivered and services rendered by a payee, the cash received in currency of the first currency jurisdiction;
associate with machine-readable data identifying the payee machine-readable data identifying the account and an amount to be applied in payment against the account;
provide the data identifying the payee, the data identifying the account, and the data identifying the amount to a payment clearing server, for payment of the amount to the payee through the payment clearing server by a trusted agent having electronic payment capability in the second currency jurisdiction;
receive, from the trusted agent through the payment clearing server, machine readable-data confirming that payment of the amount against the account has been accepted; and
provide to the payor in human-readable form confirmation that the payment was made.

29. The system of claim 28, wherein the amount to be applied in payment against the account and associated with the data identifying the payee is identified in currency of the second currency jurisdiction.

30. The system of claim 29, wherein the amount to be applied in payment against the account and associated with the data identifying the payee is identified in currency of the first currency jurisdiction.

31. The system of claim 29, comprising computer readable media configured for causing the one or more processors to refund to the payor any overpayment.

32. The system of claim 31, wherein the overpayment comprises a failed payment.

33. The system of claim 29, wherein processing remittance payments occurs in real-time.

34. A system for processing remittance payments, the system comprising one or more computer processors and computer readable media configured for causing the one or more processors to:
receive from a remittance collector in a first currency jurisdiction machine-readable data identifying a payee, an account maintained in a second currency jurisdiction for at least one of goods delivered and services rendered by the payee, and an amount collected from a payor for application as payment against the account, the amount collected in currency of the first currency jurisdiction;
provide the data identifying the payee, the account, and the amount to be paid against the account to a trusted agent having electronic payment capability in the second currency jurisdiction, for payment by the trusted agent of the amount against the account;
receive, from the trusted agent, machine readable-data confirming that payment of the amount against the account has been accepted by the payee; and
provide the data confirming payment of the amount to the remittance collector, for use by the remittance collector in providing to the payor, in human-readable form, confirmation that the payment has been made.

35. The system of claim 34, wherein the amount to be applied in payment against the account and associated with the data identifying the payee is identified in currency of the second currency jurisdiction.

36. The method of claim 34, wherein the amount to be applied in payment against the account and associated with the data identifying the payee is identified in currency of the first currency jurisdiction.

37. A system for collecting payments for remittance to a plurality of accounts, the system comprising one or more computer processors and computer readable media configured for causing the one or more processors to:
receive from at least one remittance collector in a first currency jurisdiction machine-readable data identifying a plurality of payees, a plurality of accounts maintained in at least one second currency jurisdiction for at least one of goods delivered and services rendered by the payees, and amounts collected from a plurality of payors for application as payment against the accounts, the amounts collected in currency of the first currency jurisdiction;
provide the data identifying the payees, the corresponding accounts, and the amounts to be paid against the accounts to at least one trusted agent having electronic payment capability in the second currency jurisdiction, for payment by the at least one trusted agent of the amounts against the accounts;
receive, from the trusted agent, machine readable-data confirming that payment of the amount against the account has been accepted by the payee; and
substantially simultaneously collect the plurality of amounts from the at least one remittance collector.

38. The method of claim 37, wherein collecting the plurality of amounts comprises electronically collecting the amounts.

39. The method of claim 37, wherein the collecting the plurality of amounts substantially simultaneously occurs periodically.
